(19) United States
(12) Patent Application Publication
(10) Pub. No.: US 2011/0286792 A1
(43) Pub. Date: Nov. 24, 2011

(54) ARTICLE OF FURNITURE WITH LOCK MITER JOINTS

(75) Inventors: Jay M. Henriott, Jasper, IN (US); Rod Shelton, English, IN (US)

(73) Assignee: KIMBALL INTERNATIONAL, INC., Jasper, IN (US)

(21) Appl. No.: 12/784,714

(22) Filed: May 21, 2010

(51) Int. Cl. F16B 12/00; A47B 96/00; B23P 11/00

(52) U.S. Cl. 403/375; 29/428; 29/525.01

(57) ABSTRACT

A cabinet, appearing from the outside to have a construction including fully mitered joints between its panels, internally includes hidden lock miter joints between its panels. The cabinet includes a plurality of panels and has a first panel including a joint edge having a length including a first portion adjacent a second portion. The first portion includes a mitered face disposed at an angle with respect to the first panel, and the second portion includes a lock receiving recess. The cabinet also has a second panel including a joint edge having a length including a first portion adjacent a second portion. The first portion of the second panel includes a mitered face disposed at an angle with respect to the second panel, and the second portion includes a lock protrusion. When the first and second panel attach to one another, the lock protrusion is received within the lock receiving recess and the mitered faces are in flush contact with one another.

### BACKGROUND

1. Field of Invention

The present invention relates to articles of furniture, such as cabinets, for example, that include a plurality of panels connected by joints and, in particular, to an article of furniture including panels connected by lock miter joints.

2. Description of Related Art

Known articles of furniture, such as cabinets, typically include mitered joints in which surfaces are connected to one another at 45° angles. Specifically, miter joints may be formed between top, back, and side panels where the miter joint is angled with respect to the panels. A miter joint generally presents a pleasing aesthetic, but such a joint is very difficult to machine and to index, particularly in situations where furniture for which it is used is assembled after the panels are prepared and finished. As cracks or reveals between the panels are generally unacceptable, the furniture panels need to be assembled tightly together without cracks or misalignments between the miter joints of the panels. Further, it is desirable that the furniture is able to be broken down into individual parts for disposal or recycling at the end of its life.

Certain hardware fittings, such as cam lock fittings, may be used to connect furniture panels at a miter joint. If these fittings are not aligned, however, a misalignment may be present at the joint between a pair of panels. Additionally, if the cam lock fasteners are not able to precisely draw and maintain the panels together, the panels may slip or become misaligned during use. Further, when forming a joint between three panels, such as a top, side, and a rear panel, the mitered panels need to be pulled together in three directions. Joints between three panels can be difficult to assemble and require a large number of cam lock fasteners in the furniture assembly, which is generally visually unacceptable.

Some examples of known constructions for assembling furniture panels are shown in FIGS. 1 and 2. Referring to FIG. 1, a portion of an article of furniture is shown including first panel 20 and second panel 21 connected to one another by third panel 22 positioned between first and second panels 20 and 21. Identical joint arrangements between first and third panels 20 and 22 and second and third panels 21 and 22 include a type of lock miter joint, shown in the form of a tongue and groove structure 25 combined with mitered joint interface 24, where the joint extends along the entire length of the panel edges.

Glue (not shown) is applied along the joints. Cleats 26 are connected to the joined, internal surfaces of the walls by fasteners 28 and 30 to pull mitered edges 24 together and hold them in position until the glue dries. Wood putty, or filler, is then applied to the outer mitered edges of the joints and the outer edges are sanded and finished.

Disadvantages exist with this known construction. First, the use of glue is cumbersome, particularly if the article of furniture is assembled at its use location. Additionally, cleats 26 remain in place after the glue dries and project into the interior space, thereby preventing the full use of the interior space of the cabinet.

Referring to FIG. 2, another known construction of a miter joint is shown for an article of furniture where, prior to finish, glue is positioned in the joint and a bar clamp is used to draw the joint together to allow the glue to dry. A portion of an article of furniture is shown including first panel 32 and second panel 33 connected to one another by third panel 34 positioned between first and second panels 32 and 33. Identical joint arrangements between the first and third panel and the second and the third panel include a type of lock miter joint, shown in the form of tongue and groove structure 35 combined with mitered joint interface 36, where the joint extends along the entire length of the edges 38 and 40 of the panels.

Glue (not shown) is applied between along the joints. Bar clamp 42 is then positioned to draw first and third panels 32 and 34 and second and third panels 33 and 34 together. Handle 43 of bar clamp 42 is turned to clamp the panels together while the glue dries. After the glue dries, bar clamp 42 is removed and putty is applied to outer mitered edges of the joints. The outer edges are then sanded and finished as a unit.

Disadvantageously, glue and a bar clamp need to be used with this known construction. Further, the joint arrangement is constructed and connected prior to finishing the article of furniture. As with the construction of FIG. 1, such uses and constructions are cumbersome, particularly if the article of furniture is assembled at its use location.

Other known constructions of miter joints exist where furniture parts, such as panels, of articles of furniture are assembled after finish. Examples of such constructions are shown in FIGS. 3 and 4.

FIG. 3 illustrates a joint known as a Hoffman joint. The Hoffman joint includes a plastic wedge 44 that is driven into dovetail grooves 56 in a pair of adjoining panels of an article of furniture, such as a picture frame or base, where two panels 46 and 48 abut one another. Referring to FIG. 3, first panel 46 is adjacent to and attached to second panel 48 and forms miter joint 50 running along the length of joint edges 52 and 54 of both panels 46 and 48, respectively. Grooves 56 are shaped to receive plastic wedge 44 is formed between abutting joint edges 52 and 54 of the joined first and second panels 46 and 48. Plastic wedge 44 is driven into grooves 56 to connect first and second panels 46 and 48 together. Disadvantageously, the Hoffman joint is only useful for holding together panels that are up to about three inches in length, and the use of longer panels often results in deformation of wedge 44 upon insertion into the grooves.

Referring to FIG. 4, first panel 58 including joint edge 60 is adjacent to and connected to second panel 62 including joint edge 64 where joint edges 60 and 64 include mitered faces extending the entire length of joint edges 60 and 64. Each of first panel 60 and second panel 64 include bores 66 such that, when panels 58 and 62 are connected, bores 66 for an L-shape that receives L-shaped cam lock fastener 67. A pair of cams 68A and 68B then cammingly engage head portions 67A of fastener 67. Such fasteners, however, are expensive. Further, due to the tolerances between the fastener and the bores, there is often some “play” in the joint such that joint edges 60 and 64 can become misaligned.

For each of the known constructions described above, the joint extends along the entire length of the edges of the panels that are connected, allowing for exposure of the joint at each end of the connected panel edges and for light to pass through the joint along any cracks or misalignments that may form.

### SUMMARY

The present disclosure provides a cabinet that appears from the outside to have a construction including fully mitered joints between its panels but includes hidden lock miter joints between its panels. In an embodiment, a cabinet includes a plurality of panels and has a first panel including a joint edge having a length including a first portion adjacent a second portion. The first portion includes a mitered face disposed at an angle with respect to the first panel, and the second portion includes a lock receiving recess. The cabinet also has a second panel including a joint edge having a length including a first portion adjacent a second portion. The first portion of the second panel includes a mitered face disposed at an angle with respect to the second panel, and the second portion includes a lock protrusion. When the first and second panel attach to one another, the lock protrusion is received within the lock receiving recess and the mitered faces are in flush contact with one another. In this manner, a “hybrid” joint is formed, which includes a first portion having a traditional miter connection and a second portion with a lock miter joint.

In one form thereof, a cabinet includes a plurality of panels, and the cabinet includes a first panel including a joint edge having a length including a first portion adjacent a second portion, the first portion including a mitered face disposed at an angle with respect to the first panel, the second portion including a lock receiving recess, and a second panel including a joint edge having a length including a first portion adjacent a second portion, the first portion including a mitered face disposed at an angle with respect to the second panel, the second portion including a lock protrusion, the first and second panels attached to one another with the lock protrusion received within the lock receiving recess and the mitered faces in flush contact with one another.

In another form thereof, the present disclosure provides a method of assembling a cabinet having a plurality of panels, the method including providing a first panel having a joint edge, the joint edge having a length including a first portion adjacent a second portion, the first portion including a mitered face disposed at an angle with respect to the first panel, the second portion including a lock receiving recess; providing a second panel having a joint edge, the joint edge having a length including a first portion and a second portion, the first portion including a mitered face disposed at an angle with respect to the second panel, the second portion including a lock protrusion; and inserting the lock protrusion of the second panel into the lock receiving recess of the first panel such that the mitered faces are in flush contact with one another.

### BRIEF DESCRIPTION OF THE DRAWINGS

The above-mentioned and other features and advantages of this disclosure, and the manner of attaining them, will become more apparent and the invention itself will be better understood by reference to the following descriptions of embodiment of the invention taken in conjunction with the accompanying drawings, wherein:

FIG. 1 is a sectional view of a first known miter joint arrangement;

FIG. 2 is a sectional view of a second known miter joint arrangement;

FIG. 3 is a perspective view of a third known miter joint arrangement;

FIG. 4 is a sectional view of a fourth known miter joint arrangement;

FIG. 5 is a front perspective view of a cabinet including panels joined by joints according to the present disclosure;

FIG. 6 is a rear perspective view of the cabinet of FIG. 5;

FIG. 7 is a fragmentary view of a portion of a joint of the cabinet of FIG. 5;

FIG. 8 is an exploded cross-sectional view of the joint of FIG. 7 taken along line 8-8 of FIG. 7;

FIG. 9 is a perspective view of a portion of an interior side of a first panel of the cabinet;

FIG. 10 is a side perspective view of an interior side of a second panel of the cabinet;

FIG. 11, is an exploded view showing assembly of the first and second panels of FIGS. 9 and 10;

FIG. 12 is an assembled view of the joint formed in the manner shown in FIG. 11;

FIG. 13 is a cross-sectional view of the joint of FIG. 12 taken along line 13-13 of FIG. 12;

FIG. 14 is an elevated view of a portion of the back panel of the cabinet;

FIG. 15 is an exploded rear perspective view of the back panel and the assembled first and second panels of the cabinet; and

FIG. 16 is an assembled rear view of the back panel and first and second panels of the cabinet.

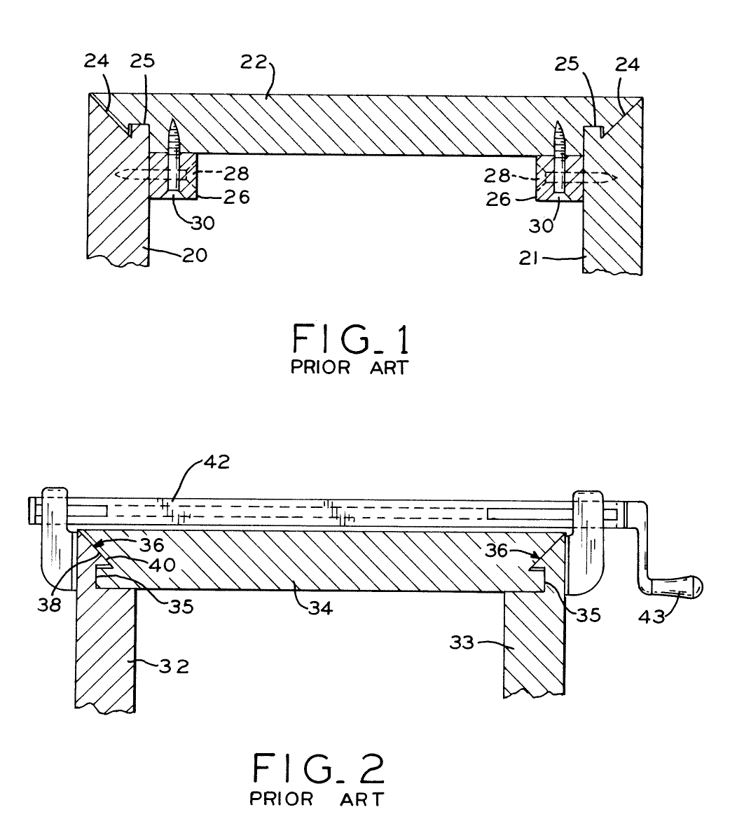

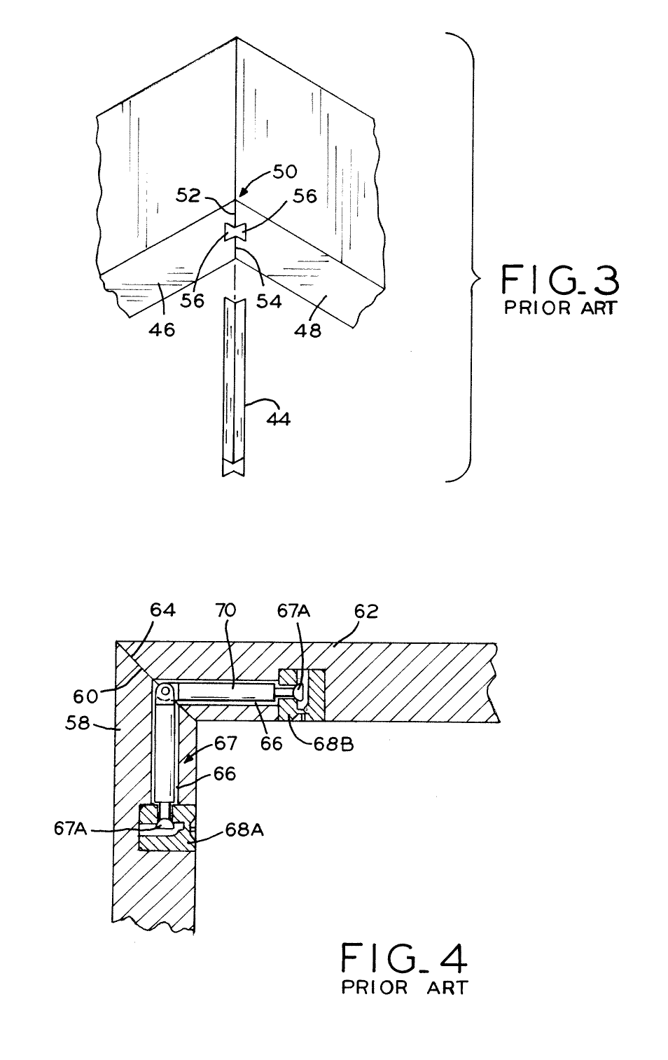

Corresponding reference characters indicate corresponding parts throughout the several views. The exemplifications set out herein illustrate exemplary embodiments of the invention, and such exemplifications are not to be construed as limiting the scope of the disclosure in any manner.

### DETAILED DESCRIPTION

An article of furniture, such as a cabinet, may include a plurality of panels made of wood or other materials, such as medium density fiberboard (MDF), for example, that may be cut, machined, or otherwise finished with tools. The panels are joined together by joint arrangements including a first portion having a mitered connection, with mutually contacting faces that are angled with respect to the panels. A second portion of the joint arrangement includes a hidden lock miter joint that is not exposed or visible at either end of the connected panels.

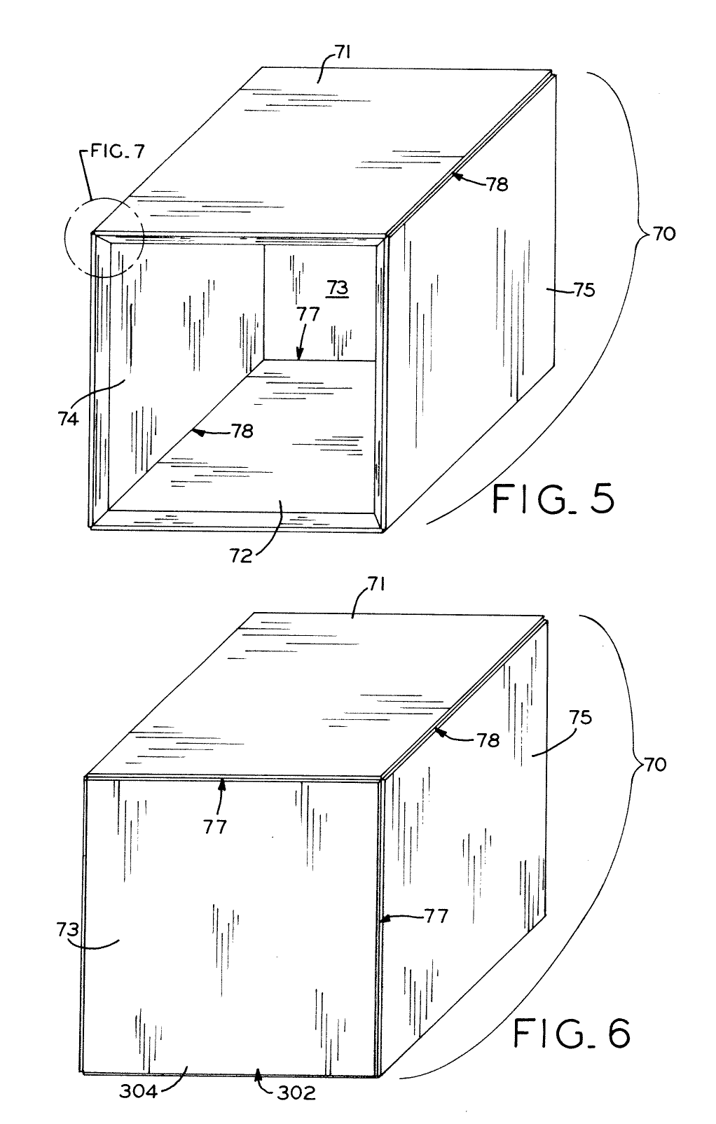

Referring to FIGS. 5 and 6, an exemplary article of furniture is shown in the form of cabinet 70, which includes a plurality of panels joined by joints according to the present disclosure, as discussed below. Cabinet 70 may be a freestanding cabinet, or may be part of a desk, credenza, office partition system, or other article of office furniture. The plurality of panels includes top panel 71, bottom panel 72, rear panel 73 and a pair of side panels 74 and 75. Each side panel 74 and 75 is attached to top panel 71, bottom panel 72 and rear panel 73 such that the assembled panels combine to form cabinet 70.

Cabinet 70, when assembled, has an open front end, a closed rear end, four rear joints 77, and four side joints 78. Each rear joint 77 is formed from one of the rear edges of side panel 74, side panel 75, top panel 71, and bottom panel 72 connecting with an edge of rear panel 73. Each side joint 78 is formed from a side edge of either top panel 71 or bottom panel 72 connecting with a side edge of one of side panels 74 and 75. In the discussion below, a side joint is discussed generically as a joint between two panels, including a first panel and a second panel, it being understood that the first panel may be a side, bottom, or top panel and the second panel may be any adjoining panel.

Advantageously, the cabinet joints have flat surfaces to index to and which may be created by CNC-precise machining. For example, a first panel may machined to include a lock protrusion and a second panel may be machined to include a lock receiving recess. The first and second panels index together and the lock protrusion fits into the lock receiving recess. Alternatively, the second panel may include the lock protrusion and the first panel may include the lock receiving recess. In other embodiments, any of the top, bottom, or side panels may include either a lock protrusion or a lock receiving recess that indexes with the opposite feature in an adjoining panel.

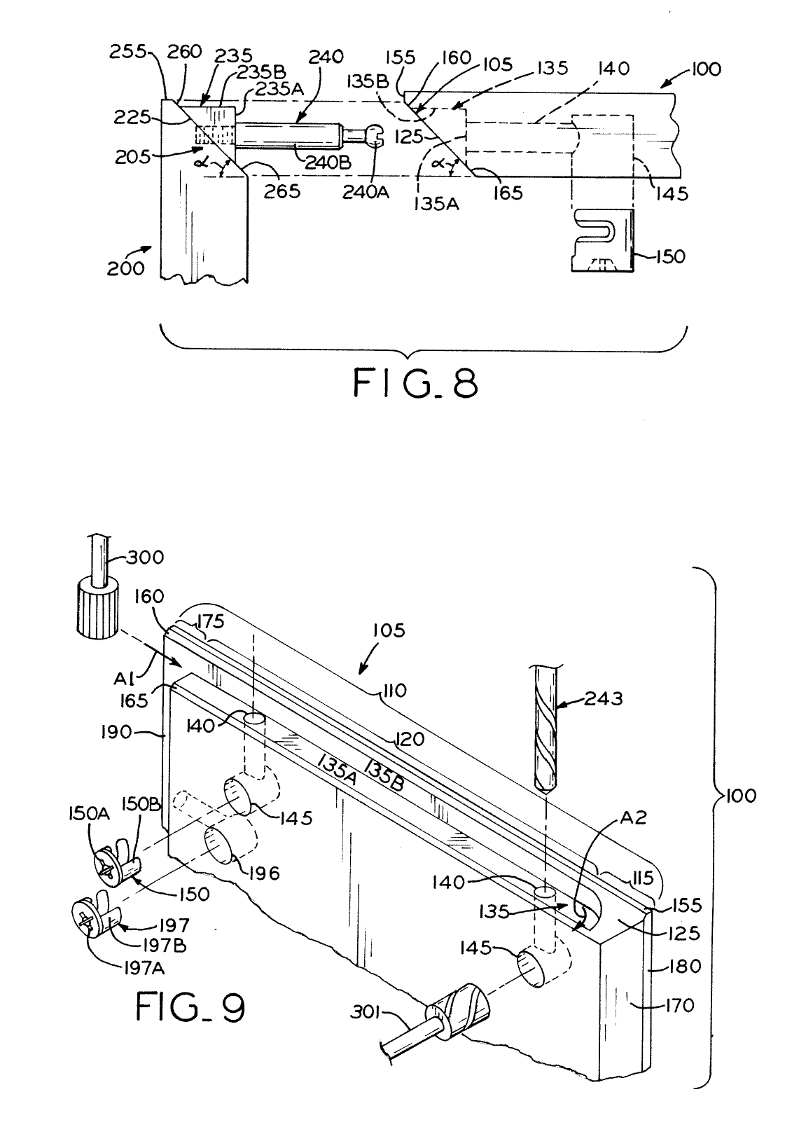

Referring to FIGS. 8 and 9, first panel 100 includes joint edge 105 that has length 110 including first portion 115 and second portion 120. First portion 115 includes mitered face 125 disposed at angle α with respect to first panel 100. The angle may be, for example, about 45°. Second portion 120 includes lock receiving recess 135. Router 300 may be used to machine lock receiving recess 135 in the panel along the direction of arrow A1 and to form a curved end by machining along the direction of arrow A2.

Drill 301 may be used to form a first bore 145 having a relatively larger diameter for receiving the cam 150 of a cam lock fastener, and another drill 243 may form a second, relatively smaller diameter fastener receiving bore 140 perpendicular to, and joining, bore 145, which receives the shank of the cam lock fasteners, as described below.

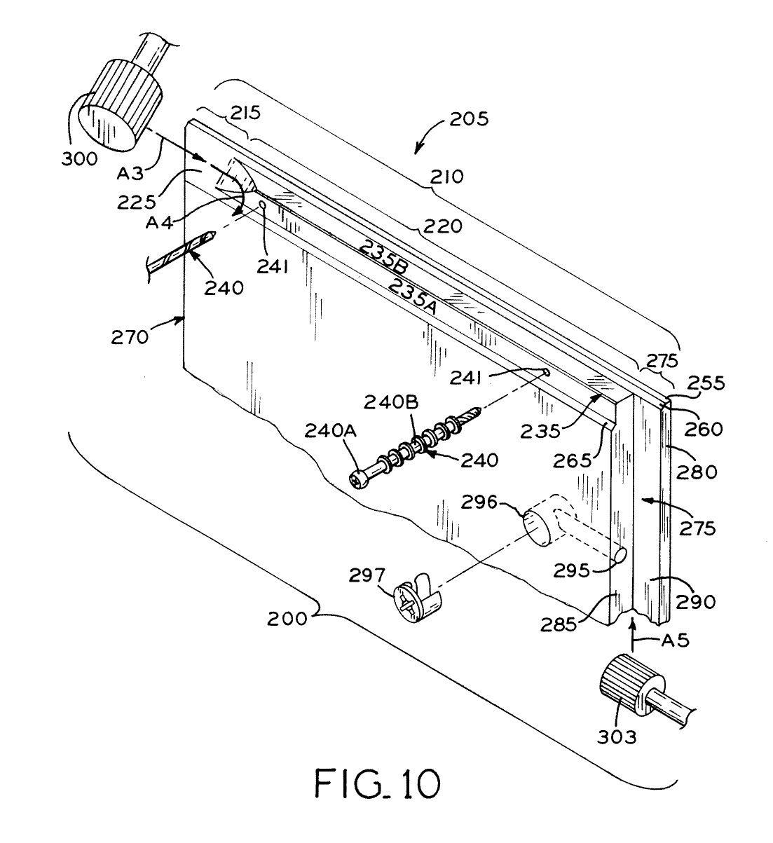

Referring back to FIG. 9, mitered face 125 of first panel 100 extends along length 110 of joint edge 105 at a range of about 2% to 20%, or at a range of about 2% to 50%, of length 110. Lock receiving recess 135 extends along length 110 of joint edge 105 at a range of about 80% to 98%, or at a range of about 50% to 98%, of length 110. Thus, lock receiving recess 135 has a length equal to or greater than lock protrusion 235. Other ranges for the extension of mitered face 125 of first panel 100 along length 110 of joint edge 105 includes a range of about 4% to 6% of length 110. Lock receiving recess 135 may extend along length 110 at a range of about 94% to 96%. Additionally, first back panel relief 175 may be positioned along joint edge 105 at a range of about 2% to 8%, or 4% to 6%, of length 110 of joint edge 105. Router 303 (FIG. 10) may be used to machine any back panel reliefs that are within the scope of this disclosure, such as second back panel relief 275 of second panel 200, where second back panel relief 275 is formed via machining along the direction of arrow A5.

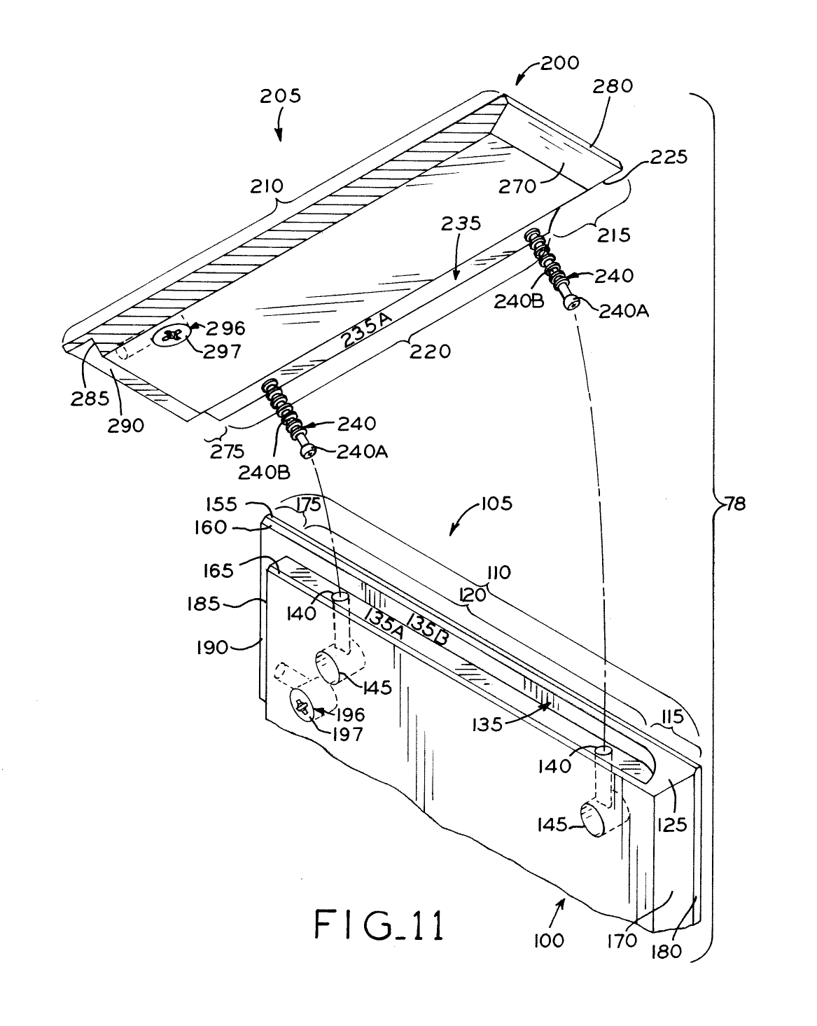

Lock receiving recess 135 (FIG. 9) includes surfaces 135A and 135B forming a right angle with respect to one another. Disposed at opposite sides of lock receiving recess 135 are first mitered sub-portion 160 and second mitered sub-portion 165, which are also disposed at angle α with respect to first panel 100. Lock receiving recess 135 further includes fastener receiving bore 140 disposed within surface 135A to receive fastener 240 (FIG. 11) projecting from bore 241 of lock protrusion 235. Fastener 240 has enlarged head 240A and shank 240B including a threaded portion.

Referring back to FIG. 9, first panel 100 further includes cam receiving bore 145 having cam 150, which includes head 150A and shank 150B, with head 150A in camming engagement with head 240A of respective fastener 240 (FIG. 10) of second panel 200 when first panel 100 is attached to second panel 200.

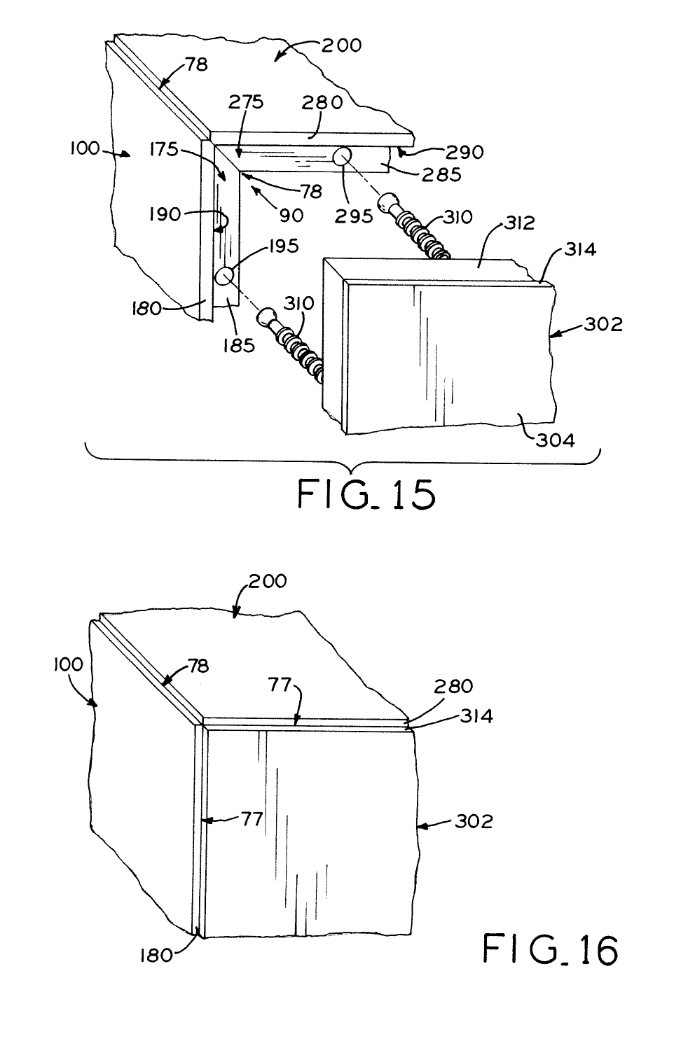

A front panel opening of cabinet 70 includes front mitered edge 170 perpendicular to joint edge 105. Further extending from joint edge 105 on both a front and rear end of panel 100 is exterior end 180. Joint edge 105 of first panel 100 includes first back panel relief 175 adjacent lock receiving recess 135. First back panel relief 175 forms a portion of cavity 90 (FIG. 15). First back panel relief 175 includes support wall 190 and fastener receiving panel 185 (FIGS. 11 and 15).

First panel 100 includes cam receiving bore 196 including cam 197 having head portion 197A and shank 197B. Shank 197B includes a curved slot that cammingly engages enlarged head 310A of back panel fastener 310 (FIG. 15). Cam 197 of the cam lock fasteners disclosed herein includes a head portion and a shank, and is used to cammingly engage with a respective fastener head to tightly draw together and engage edges of two adjoining panels. Advantageously, the number of cam lock fasteners as used in the prior known construction is greatly reduced by the embodiment of the present disclosure.

Referring to FIGS. 8 and 10, second panel 200 includes joint edge 205 having length 210 including first portion 215 adjacent second portion 220. First portion 215 includes mitered face 225 disposed at angle α with respect to second panel 100. Angle α may be those angles as disclosed with respect to angle α of first panel 100. The angle may be, for example, a 45° angle. Alternatively, the angle may be an angle that, combined with the angle of mitered face 125 of first panel 100, creates a 90° angle.

Second portion 220 of joint edge 205 includes lock protrusion 235. Lock protrusion 235 extends along length 210 at a range of about 80% to 98%, or at a range of about 50% to 98%, of length 110, but has a length less than that of lock receiving recess 135. Mitered face 225 of second panel 200 extends along length 210 at a range of about 2% to 20%, or at a range of about 2% to 50%, of length 210. Second back panel relief 275 may be positioned along joint edge 205 at a range of about 2% to 8%, or 4% to 6%, of length 210 of joint edge 205. Another range for the extension of mitered face 225 of second panel 200 along length 210 of joint edge 205 includes a range of about 4% to 6% of length 210. Additionally, lock protrusion 235 may extend along length 210 at a range of about 94% to 96%, but has a length equal to or less than that of lock receiving recess 135.

Lock protrusion 235 also includes projecting fastener 240 and surfaces 235A and 235B that form a right angle with respect to one another. Lock protrusion 235 includes opening 241 from which fastener 240 projects. Disposed at opposite sides of lock protrusion 235 are first mitered sub-portion 260 and second mitered sub-portion 265, which are also disposed at angle α with respect to second panel 200.

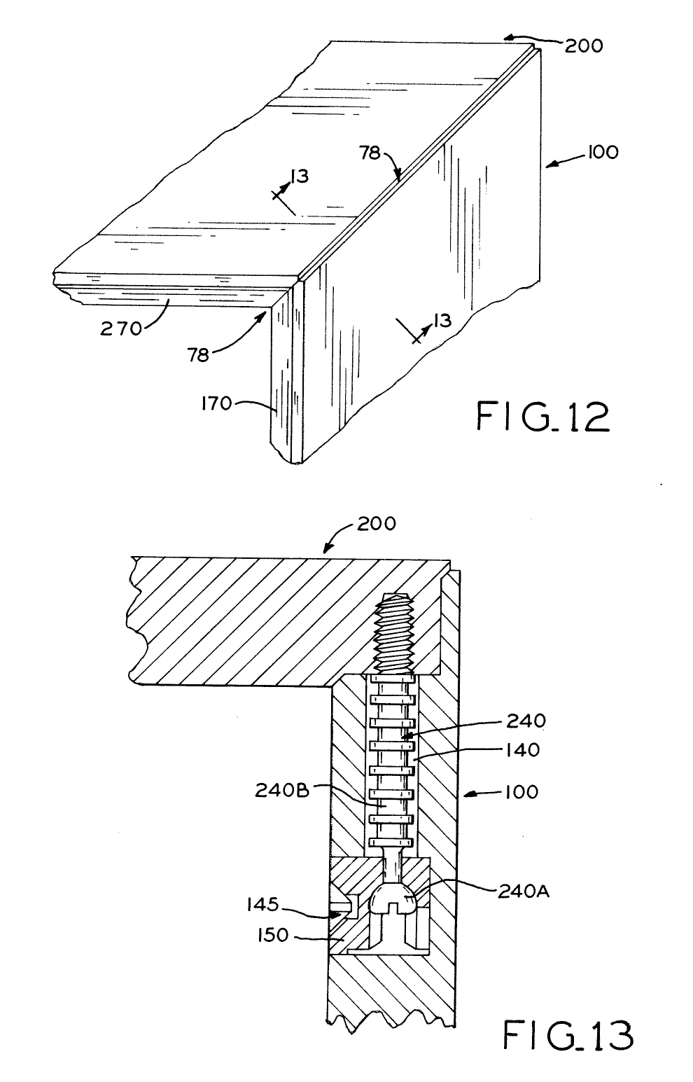

The front of cabinet 70 includes an opening having front mitered edge 270 perpendicular to joint edge 205 along with exterior end 280 extending from joint edge 205 at both front and rear ends of panel 200. When panels 100 and 200 are assembled, as shown in FIG. 12, front mitered edges 170 and 270 are perpendicular to one another as are exterior ends 180 and 280.

Towards the rear of cabinet 70, joint edge 205 of second panel 200 includes second back panel relief 275 adjacent lock protrusion 235. Second back panel relief 275 includes fastener receiving panel 285 having corresponding hole 295 and support panel 290. Corresponding hole 295 receives fastener 310 of panel 302 (FIG. 15) and cam 297 is inserted into cam receiving bore 296 of second panel 200 to engage in camming action with head 310A of fastener 310. Mitered face 225 may be machined, or shaped, by router 300 along the direction of A3, the machining ending along the direction of arrow A3.

FIG. 11 illustrates first panel 100 and second panel 200 in an exploded preassembly view. Fasteners 240 of second panel 200 are received into fastener receiving bores 140 of first panel 100. Lock protrusion 235 of second panel 200 is received into lock receiving recess 135 of first panel 100 when first panel 100 is attached to second panel 200, and mitered faces 125 and 225 flushly contact one another. Cam 150 of first panel 100 including head portion 150A and shank 150B, is inserted within cam-receiving bore 145 to engage head 240A of fastener 240 in camming engagement, tightly drawing first panel 100 toward second panel 200. As front mitered edge 170 is proximate and substantially perpendicular to first portion 115 of first panel 100, and front mitered edge 270 is proximate and substantially perpendicular to first portion 215 of second panel 200, front mitered edge 170 of first panel 100 is perpendicular to front mitered edge 270 of second panel 200 when the panels are attached.

FIG. 11 further shows each of first panel 100 and second panel 200 including cam receiving bores 196 and 296, respectively. The panels respectively include cams 197 and 297 meant for camming engagement with head 310A of fastener 310 (FIG. 15) of back panel 302 once back panel 302 is attached to the already attached first and second panels 100 and 200.

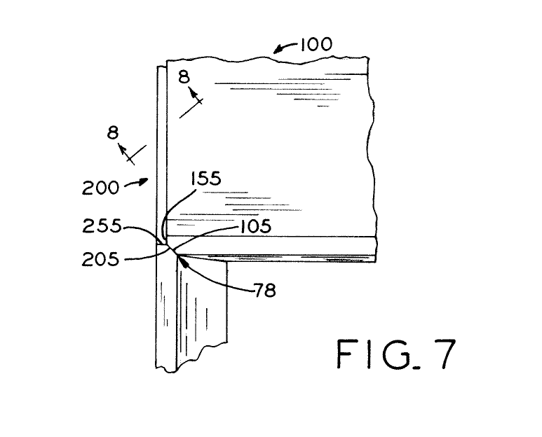

The joint as assembled is shown in FIG. 5, and FIG. 7 shows a fragmentary view of such joint where a chamfer is machined onto a front of the panel and into an upper edge of the board, allowing for an outside miter construction. In an aspect, first panel 100 includes first panel lip end 155 adjacent joint edge 105 and second panel 200 include second panel lip end 255 adjacent joint edge 205. The outside mitered construction is shown as first panel lip end 155 is substantially spaced from second panel lip end 255 when second panel 200 is received into first panel 100. First panel 100 is attached to second panel 200 such that first panel lip end 155 is spaced from second panel lip end 255 at about a 90° angle, though other angles and spacing are possible. Alternatively, first panel lip end 155 may be flush against second panel lip end 255. Joint edge 105 of first panel 100 is flush with joint edge 205 of second panel 200 when the joint is assembled, creating side joint 78.

FIG. 8 illustrates a detailed preassembly cross-sectional view of the joint of FIG. 7. As shown in FIGS. 8 and 9, first panel 100 first panel lip end 155 extends from joint edge 105. Fastener receiving bore 140 extends internally from lock receiving recess 135 and connects with cam receiving bore 145 meant to receive cam 150. Second panel 200, shown in FIGS. 8 and 10, further includes second panel lip end 255 extending from joint edge 205. Lock protrusion 235 of second panel 200 includes projecting fastener 240 received into fastener receiving bore 140 of first panel 100. When first panel 100 and second panel 200 are attached, respective first mitered sub-portions 160 and 260 flushly engage one another as do respective second mitered sub-portions 165 and 265.

FIG. 12 illustrates another fragmentary view of the assembled joint of the present disclosure, showing side joint 78 formed from the attachment of first panel 100 to second panel 200 including front mitered edges 170 and 270, which are positioned perpendicular to one another. A cross-sectional view of joint 78 is shown in FIG. 13. First panel 100 is attached to second panel 200 via fastener 240 of panel 200 being received into fastener receiving bore 140 of first panel 100. Cam 150 is rotated within cam receiving bore 145 to engage in camming engagement with enlarged head 240A of fastener 240, drawing panels 100 and 200 together.

First and second panels 100 and 200 may include the joint construction as described above in the present disclosure including joint edges 105 and 205 having mitered faces 125 and 225 and lock protrusion 235 and lock receiving recess 135, respectively, or may optionally include the same construction as described absent lock protrusion 235 and lock receiving recess 135 and any associated features of lock protrusion 235 and lock receiving recess 135.

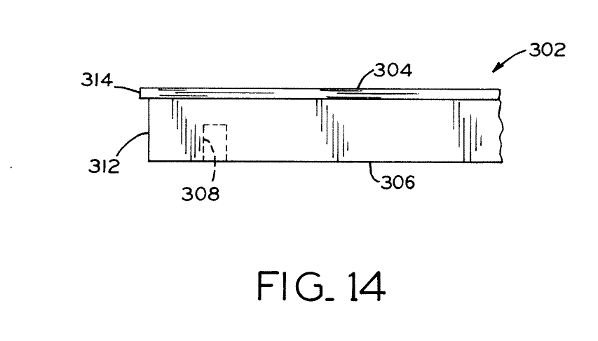

After the top, side, and bottom panels of cabinet 70 are assembled to form a front open end (FIG. 5), a back panel may be fitted within a cavity formed at the rear end of the assembled top, side, and bottom panels to create a closed rear end of cabinet 70 (FIG. 6). Referring to FIG. 14, back panel 302 is shown to include exterior face 304, opposing interior face 306 having bore 308, support wall 312 positioned between exterior face 304 and opposing interior face 306, and lip 314. Bore 308 contains projecting fastener 310 (FIG. 15) having a head 310A, which may be enlarged, and shank 310B including a threaded portion. Lip 314 defines a portion of exterior face 304 of back panel 302.

As illustrated in FIG. 15, adjoined panels of cabinet 70 form a space shown as recessed area or cavity 90 at a rear of the panels to receive back panel 302. FIG. 15 shows a fragmentary mid-assembly view of an exterior rear corner of cabinet 70 where back panel 302 includes projecting fasteners 310 and first panel 100 is attached to second panel 200 to form cavity 90 at a rear end of first and second panels 100 and 200.

First panel 100 includes fastener receiving wall 185 having hole 195 meant to receive fastener 310, and second panel 200 includes fastener receiving wall 285 having hole 295 meant to receive fastener 310 of back panel 302. Positioned substantially perpendicularly to fastener receiving walls 185 and 285 are support walls 190 and 290 of first and second panels 100 and 200, respectively. Back panel 302 is received into first and second back panel reliefs 175 and 275 when first panel 100 is attached to second panel 200, and first and second panels 100 and 200 are attached to back panel 302 to form rear joint 77. Front mitered edges 170 and 270 are then perpendicular to one another with interfaces that flushly contact one another to form a part of side joint 78. First and second back panel reliefs 175 and 275 are positioned to receive back panel 302 when second panel 200 is received into first panel 100.

When back panel 302 is received into cavity 90, support walls 312 of back panel 302 flushly fit against support walls 190 and 290 of first and second panels 100 and 200, respectively. Joint edge 105 of first panel 100 further includes first back panel relief 175 adjacent lock receiving recess 135, while joint edge 205 of second panel 200 includes second back panel relief 275 adjacent lock protrusion 235.

When assembled, first and second back panel reliefs 175 and 275 form cavity 90. Particularly, cavity 90 is formed from fastener receiving walls 185 and 285 of first panel 100 and second panel 200, respectively, and support wall 190 and 290 of first and second panels 100 and 200, respectively. At least one respective fastener 310 of back panel 302 is received into at least one corresponding hole 195 or 295 of fastener receiving walls 185 and 285, respectively, and support walls 312 of back panel 302 flushly contact support walls 190 and 290 of cavity 90.

Cam 197 (FIG. 9) includes a shank portion that connects with enlarged head 310A of back panel fastener 310 (FIG. 15) when fastener 310 is inserted into hole 195 of fastener receiving wall 185 of first panel 100. First wall 100 and back panel 302 have abutting edges and walls, particularly support wall 312 of back panel 302 abutting with support wall 190 and a portion of interior face 306 of back panel 302 abutting fastener receiving wall 185. The shank portion of cam 197 is positioned over the enlarged head of fastener 310 and rotated to lock in fastener 310 while tightly engaging first wall 100 with back panel 302.

As discussed above and illustrated in FIG. 15, second panel 200 includes exterior end 280 perpendicular to joint edge 205 of second panel 200, and first panel 100 includes exterior end 180 perpendicular to joint edge 105 of first panel 100. Lip 314 fits upon exterior ends 180 and 280 at the rear of first and second panels 100 and 200, respectively. Lip 314 may fit upon a portion of exterior ends 180 and 280 (FIG. 16), forming the appearance of an outer mitered construction, or lip 314 may fit upon an entire exterior end when back panel 30 is received into first and second back panel reliefs 175 and 275 (FIG. 15).

Referring to FIG. 16, when back panel 302 is connected with first panel 100 and second panel 200, rear joints 77 are formed. Back panel 302 is received into first and second back panel reliefs 175 and 275 of first and second panels 100 and 200, respectively, when first panel 100 is attached to second panels 200. Further, lip 314 defining a portion of exterior face 304 of back panel 302 sits upon at least a portion of exterior ends 180 and 280 of first panel 100 and second panel 200, respectively.

The lock mitered joint of the present disclosure ensures that different panels will fit together snugly regardless of variance in board thickness. Further, any light gaps or cracks in the joint cannot be seen as the lock miter does not extend the entire length of a joint edge of either connecting panel. As the lock miter joint of the present disclosure is hidden, the lock miter is not exposed at outer ends of the cabinet. Additionally, the visible number of many fixed fasteners in the cabinet is reduced from an amount used in the known constructions. Moreover, glue is not necessary in the present joints.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cabinet including a plurality of panels, said cabinet comprising:
a first panel including a joint edge having a length including a first portion adjacent a second portion, said first portion including a mitered face disposed at an angle with respect to said first panel, said second portion including a lock receiving recess; and
a second panel including a joint edge having a length including a first portion adjacent a second portion, said first portion including a mitered face disposed at an angle with respect to said second panel, said second portion including a lock protrusion, said first and second panels attached to one another with said lock protrusion received within said lock receiving recess and said mitered faces in flush contact with one another.

2. The cabinet of claim 1, wherein said lock receiving recess includes at least one fastener receiving bore, and said lock protrusion includes at least one projecting fastener, each said fastener received within a respective said fastener receiving bore.

3. The cabinet of claim 2, wherein said first panel includes at least one cam-receiving bore including a cam in camming engagement with a respective said fastener.

4. The cabinet of claim 1, wherein said mitered face of said first panel extends along said length of said joint edge at a range of about 2% to 50% of said length, and wherein said lock receiving recess of said first panel extends along said length of said joint edge at a range of about 50% to 98% of said length, said extension of said lock receiving recess along said joint edge of said first panel greater in length than an extension of said lock protrusion along said joint edge of said second panel.

5. The cabinet of claim 1, wherein said mitered face of said first panel extends along said length of said joint edge at a range of about 2% to 20% of said length, and wherein said lock receiving recess of said first panel extends along said length of said joint edge at a range of about 80% to 98% of said length, said extension of said lock receiving recess along said joint edge of said first panel greater in length than an extension of said lock protrusion along said joint edge of said second panel.

6. The cabinet of claim 1, wherein:
said first panel further comprises a first panel lip end adjacent said joint edge;
said second panel further comprises a second panel lip end adjacent said joint edge; and
said first panel lip end is perpendicular to said second panel lip end when said second panel is received into said first panel.

7. The cabinet of claim 1, wherein
said first panel further includes first and second mitered sub-portions extending along opposite sides of said lock receiving recess;
said second panel further includes first and second mitered sub-portions extending along opposite sides of said lock protrusion,
said first and second mitered sub-portions of said first panel in respective flush contact with said first and second mitered sub-portions of said second panel.

8. The cabinet of claim 1, said first panel further comprising a front mitered edge proximate and substantially perpendicular to said first portion of said first panel, and said second panel further comprising a front mitered edge proximate and substantially perpendicular to said first portion of said second panel.

9. The cabinet of claim 1, further comprising:
a back panel;
said joint edge of said first panel including a first back panel relief adjacent said lock receiving recess;
said joint edge of said second panel including a second back panel relief adjacent said lock protrusion;
a cavity defined by said first and second back panel reliefs, said back panel received in said cavity when said first panel is attached to said second panel.

10. The cabinet of claim 9, said cabinet comprising a top panel, a bottom panel, a pair of side panels, and a rear panel, each of said pair of side panels attached to said top panel, said bottom panel, and said rear panel in an assembled form.

11. A method of assembling a cabinet having a plurality of panels, said method comprising:
providing a first panel having a joint edge, the joint edge having a length including a first portion adjacent a second portion, the first portion including a mitered face disposed at an angle with respect to the first panel, the second portion including a lock receiving recess;
providing a second panel having a joint edge, the joint edge having a length including a first portion and a second portion, the first portion including a mitered face disposed at an angle with respect to the second panel, the second portion including a lock protrusion; and
inserting the lock protrusion of the second panel into the lock receiving recess of the first panel such that the mitered faces are in flush contact with one another.

12. The method of claim 11, wherein the step of inserting further comprises:
inserting at least one projecting fastener of the joint edge of one of the first and second panels into at least one respective fastener receiving bore of the joint edge of the other of the first and second panels.

13. The method of claim 12, wherein the step of inserting further comprises:
positioning at least one cam with a respective cam-receiving bore of one of the first and second panels;
aligning the cam within a corresponding head of the at least one projecting fastener; and
rotating the cam into camming engagement with the at least one projecting fastener.

14. The method of claim 11, further comprising the additional step of:
providing a back panel including an exterior face having a lip, an opposing interior face having at least one bore from which at least one respective fastener projects, and one or more first support walls positioned between the exterior face and the opposing interior face; and
inserting the at least one respective fastener of the back panel into at least one of a pair of fastener receiving walls, the fastener receiving walls perpendicular to a respective pair of second support walls, each fastener receiving wall and second support wall positioned within a first back panel relief of the first panel and a second back panel relief of a second panel, the first and second back panel reliefs forming a cavity to receive the back panel such that the first support walls of the back panel flushly contact the pair of second support walls of the cavity.

15. The method of claim 14, further comprising the additional step of:
positioning the lip of the back panel to sit upon at least a portion of exterior ends that are perpendicular to respective joint edges of the first and second panels after receiving the back panel into the first and second back panel reliefs.

16. The method of claim 14, further comprising the additional steps of:
positioning at least one cam within a respective cam-receiving bore of one of the first and second panels;
aligning the cam with a corresponding head of the at least one respective fastener of the back panel; and
rotating the cam into camming engagement with the at least one respective fastener.
